(19) United States
(12) Patent Application Publication
(10) Pub. No.: US 2015/0244682 A1
(43) Pub. Date: Aug. 27, 2015

(54) METHOD AND APPARATUS FOR IDENTIFYING AND PROTECTING CONFIDENTIAL INFORMATION IN A COLLABORATION SESSION

(71) Applicant: Cisco Technology, Inc., San Jose, CA (US)

(72) Inventors: Debanjan Biswas, Bangalore (IN); Sreejith Nayappakkil Thikkalveettil, Bangalore (IN)

(73) Assignee: Cisco Technology, Inc., San Jose, CA (US)

(21) Appl. No.: 14/191,717

(22) Filed: Feb. 27, 2014

(51) Int. Cl. H04L 29/06; G06F 3/0481

(52) U.S. Cl. CPC H04L 63/0428; G06F 3/0481

(57) ABSTRACT

In one embodiment, a method includes initiating a session and determining whether a first indication arranged to indicate that confidential information is to be shared during the session is obtained. The session includes a plurality of participants in attendance. The method also includes, after it is determined that the first indication is obtained, determining whether each participant of the plurality of participants has agreed to maintain confidentiality with respect to the confidential information. Finally, after it is determined that each participant of the plurality of participants has agreed to maintain the confidentiality with respect to the confidential information, a second indication is provided during the session, the second indication being arranged to indicate that the confidential information is currently being shared during the presentation.

### TECHNICAL FIELD

The disclosure relates generally to collaboration systems. More particularly, the disclosure relates to allowing confidential information shared during a collaboration session to be identified and protected.

### BACKGROUND

Collaboration systems allow participants in a sharing session or a meeting, e.g., a virtual meeting, to share desktops, applications, presentations and the like during the course of the meeting. During some meetings, confidential information may be shared. In some situations, confidential information may not be readily identified. By way of example, a shared presentation that includes confidential information may be subject to a non-disclosure agreement (NDA), but information which indicates that the shared presentation is subject to an NDA may not be clearly visible.

When information which identifies shared content as being confidential is not readily visible during a virtual meeting, participants in attendance at the meeting may not be aware that the information is to be kept confidential. As a result, participants who were in attendance at the meeting may share information meant to be confidential with outside parties, without realizing that the information is confidential information.

### BRIEF DESCRIPTION OF THE DRAWINGS

The disclosure will be readily understood by the following detailed description in conjunction with the accompanying drawings in which:

FIGS. 1A-C are a process flow diagram which illustrates a method of conducting a session, e.g., a collaboration session, during which confidential information is presented in accordance with an embodiment.

FIG. 2 is a process flow diagram which illustrates a first method of processing at least a current portion of a session or recording as being confidential, e.g., step 121 of FIGS. 1A-C, in accordance with an embodiment.

FIG. 3 is a process flow diagram which illustrates a second method of processing at least a current portion of a recording as being confidential, e.g., step 121 of FIGS. 1A-C, in accordance with an embodiment.

FIG. 4 is a diagrammatic representation of a process of supporting an addition of a new party to a session in which confidential information is being shared in accordance with an embodiment.

FIG. 5 is a diagrammatic representation of a server, e.g., a conference server, that is configured to effectively indicate and protect confidential information associated with a session in accordance with an embodiment.

### DESCRIPTION OF EXAMPLE EMBODIMENTS

### General Overview

According to one aspect, a computer-implemented method includes initiating a session, allowing a plurality of participants to participate in the session, and determining whether a first indication is obtained, the first indication being arranged to indicate that confidential information is to be shared during the session. The session includes the plurality of participants in attendance, and the plurality of participants includes at least a first participant and a second participant. The computer-implemented method also includes, after it is determined that the first indication is obtained, determining whether each participant of the plurality of participants has agreed to maintain confidentiality with respect to the confidential information. Finally, after it is determined that each participant of the plurality of participants has agreed to maintain the confidentiality with respect to the confidential information, a second indication is provided during the session and the plurality of participants are allowed to continue participating in the session, the second indication being arranged to indicate that the confidential information is currently being shared during the presentation.

### Description

By clearly identifying confidential information shared during a session or a meeting, e.g., a collaboration session, parties in attendance at the session may be readily made aware that information is confidential. As such, the probability that the parties may share the confidential information with outside parties, or parties that should not be made aware of the confidential information, may be lowered. That is, risks associated with sharing of confidential information during a session may be reduced when confidential information is clearly indicated to attendees or participants in the session.

A recording of a session in which confidential information is shared may clearly identify the confidential information so that an individual viewing the recording may be made aware that certain information is confidential, e.g., confidential information may be blacked out in a recording of a collaboration session such that the confidential information is not visible and not audible. Alternatively, a recording of a session may exclude confidential information by ceasing recording of the session while confidential information is shared, and then resuming recording of the session when confidential information is no longer being shared.

In one embodiment, before confidential information is shared during a collaboration session, each party in attendance at the collaboration session may be prompted to indicate that he or she effectively agrees to keep the confidential information substantially confidential. In such an embodiment, each party in attendance may be presented with an interface which allows the party to indicate that he or she is agreeing to keep information confidential. If a party agrees to keep information confidential, the party is allowed to view or otherwise access the information. If, however, a party does not agree to keep information confidential, the party may be precluded from viewing or otherwise accessing the information.

A host of a collaboration session may indicate that confidential information is to be shared, in one embodiment, be substantially activating a radio button in an interface associated with the collaboration session. For example, a host of a collaboration session may be presented with a display screen on which a radio button arranged to indicate confidentiality is depicted. Such a radio button may be a “confidential” button, and may be arranged to be activated to start a process of obtaining indications from substantially all parties participating in the collaboration session that the parties agree to maintain certain information as confidential. The radio button may be confidential, and confidential text may be displayed in some instances. It should be appreciated that while a host of a collaboration session is described as having the ability to indicate that confidential information may be shared, other participants in a meeting, as for example a presenter, may also have the ability to indicate that confidential information may be shared.

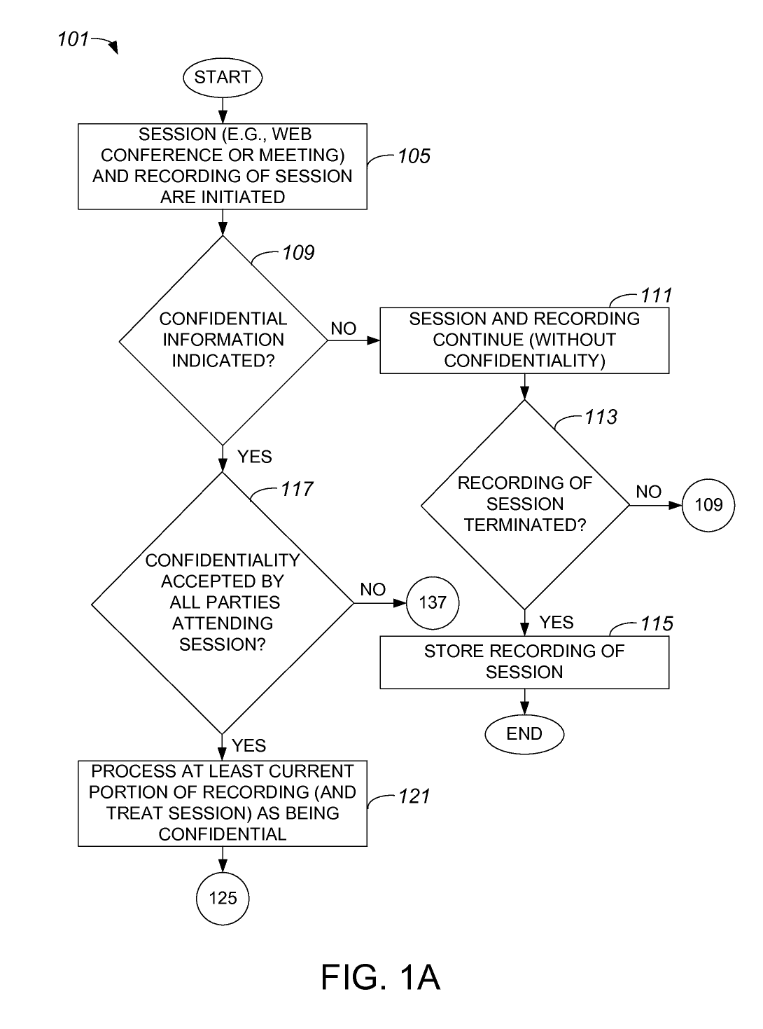

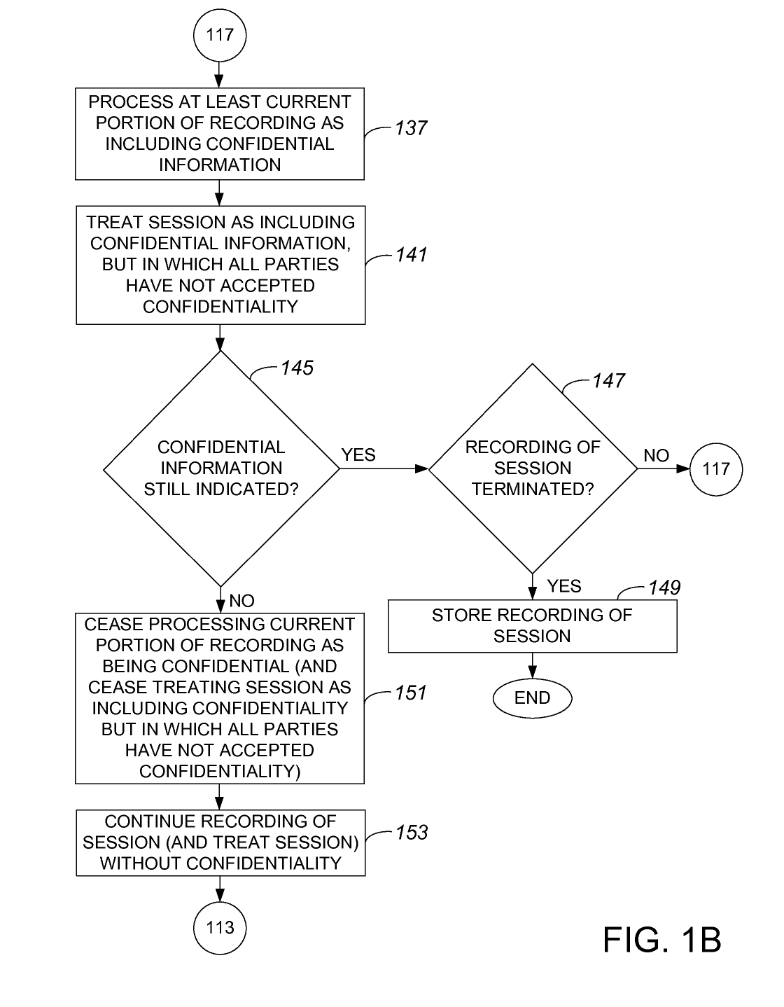

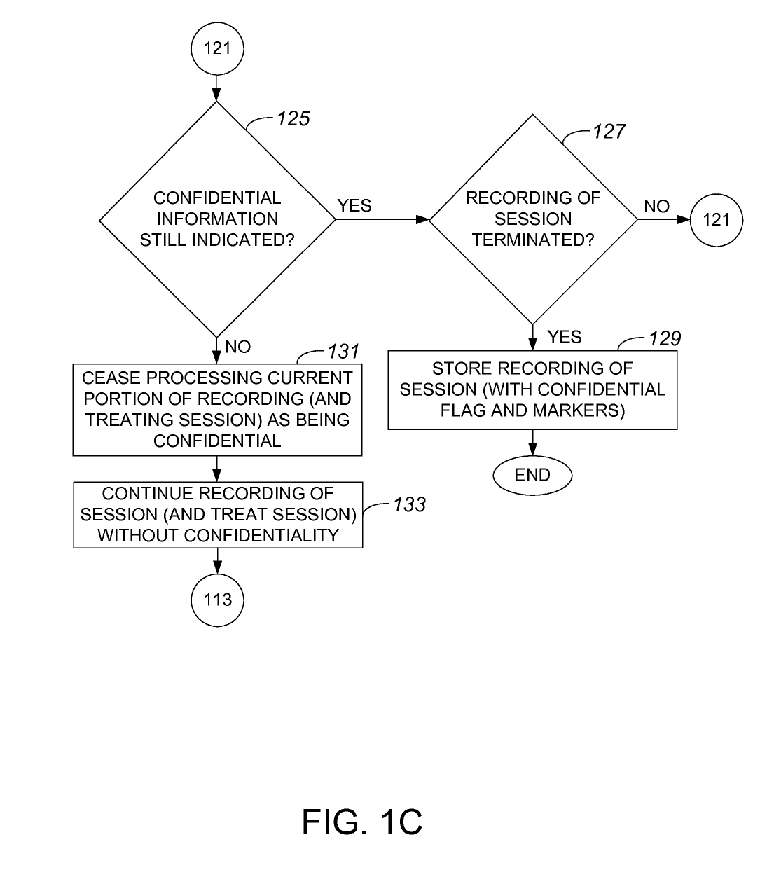

Referring initially to FIGS. 1A-C, a method of conducting a session, e.g., a collaboration session such as a web conference or a meeting, during which confidential information is shared or presented will be described in accordance with an embodiment. A method 101 of conducting a session begins at step 105 in which a session is initiated and, in the described embodiment, recorded. It should be appreciated that although the session is described as being recorded, the session is not necessarily recorded. That is, the session may be held substantially in real-time but not recorded for later access.

After the session and the recording of the session are initiated, a determination is made in step 109 as to whether confidential information is indicated. A determination of whether confidential information is indicated may include, but is not limited to including, determining whether a participant in the session has provided an indication that confidential information is being shared or about to be shared. For example, a host of a session may effectively activate an option during the session which indicates that confidential information is to be shared. It should be understood that while a host of a session is described as having the ability to activate an option during a session which indicates that confidential information is to be shared, other participants in the session, as for example a presenter, may also have the ability to activate the option. In one embodiment, a host of a session may effectively activate a radio button to indicate that confidential information is about to be shared or presented or otherwise cause text which indicates that confidential information is about to be shared or presented. It should be appreciated that confidentiality may be indicated at substantially anytime, e.g., dynamically at substantially any point during an ongoing session.

If the determination in step 109 is that confidential information is not indicated, then the session continues and the recording of the session continues substantially without confidentiality in step 111. From step 111, process flow proceeds to step 113 in which it is determined whether the recording of the session is terminated. If it is determined that the recording of the session is terminated, then the recording of the session is stored in step 115, and the method of conducting a session is completed. In the described embodiment, for ease of discussion, the session is terminated when the recording of the session is terminated. It should be appreciated, however, that a session is not necessarily terminated when a recording of the session is terminated.

Alternatively, if the determination in step 113 is that the recording of the session is not terminated, the indication is that the session and the recording of the session are ongoing. As such, process flow returns to step 109 in which it is determined whether confidential information is indicated.

If the determination in step 109 is that confidential information is indicated, then the implication is that confidentiality, e.g., a non-disclosure agreement, is to be accepted by each party attending or otherwise participating in the session before each party is substantially authorized to view or otherwise share, e.g., listen to, the confidential information. Accordingly, each party is provided with an opportunity to accept confidentiality, e.g., using an interface displayed on a screen used to view information associated with the session, and a determination is made in step 117 as to whether confidentiality has been accepted by substantially all parties attending the session.

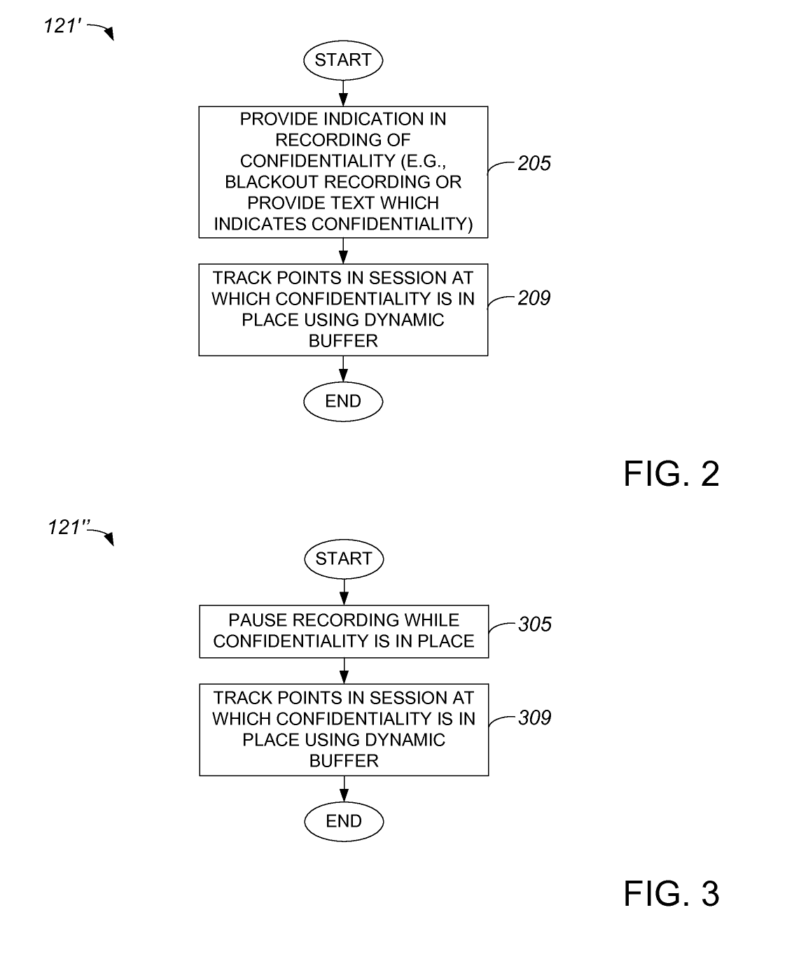

If it is determined in step 117 that confidentiality has been accepted by substantially all parties attending the session, the indication is that the session may be treated as confidential. In one embodiment, a flag associated with the session may be set to indicate that at least the current portion of the session is confidential. From step 117, process flow then moves to step 121 in which at least the current portion of the recording is processed as being confidential. It should be appreciated that the session is also treated as being confidential. Processing at least a current portion of a recording and/or a session as confidential may include, but is not limited to including, providing a visual indication in a recording and/or on a screen associated with the session which identifies at least the current portion of the session as being confidential, ceasing recording of the session when at least the current portion of the session is confidential, and effectively blacking out the part of the recording which corresponds to at least the current portion of the session that is confidential. In some embodiments, processing at least a current portion of a recording and/or a session may also include suppressing audio and/or video in a recording of a session, suppressing identities of participants in a session, and adding audio prompts or intermediate tones that may be played to participants who are attending a session substantially only using audio. Methods of processing a current portion of a recording as being confidential will be discussed below, with reference to FIGS. 2 and 3.

After at least the current portion of the recording and the session are effectively processed as being confidential, it is determined in step 125 whether confidential information is still indicated. It should be appreciated that such a determination may include, but is not limited to including, determining whether a host of a session has effectively set a flag to indicate that a current portion of the session and, hence, recording is no longer confidential. While a host is generally disclosed, such a determination may alternatively or also include determining whether a presenter associated with the session has effectively set a flag to indicate that a current portion of the session is no longer confidential.

If the determination in step 125 is that confidential information is still indicated, it is determined in step 127 whether the recording of the session is terminated or otherwise completed. If the determination is that the recording of the session has been terminated, i.e., that the session is no longer being recorded, the recording is stored in step 129. The recording may be stored as a substantially single recording, or the recording may be stored such that confidential and non-confidential portions are stored substantially separately, as for example as separate files. In one embodiment, the recording may be stored with a confidential flag and/or markers. Once the recording of the session is stored, the process of conducting a session is completed

Alternatively, if it is determined in step 127 that the recording of the session has not been terminated, then the indication is that the recording continues. As such, process flow returns to step 121 in which at least the current portion of the recording, as well as the session, are processed as being confidential.

Returning to step 125, if it is determined that confidential information is no longer indicated, then the current portion of the recording and the session are no longer treated as being confidential in step 131. In one embodiment, an indication may be provided to participants in the session which indicates that the current portion of the recording or session is not confidential. The current portion of the recording may also be identified as not being confidential, e.g., using a displayed indication. In step 133, the recording and the session continue without confidentiality. From step 133, process flow returns to step 113 in which it is determined if the recording of the session is terminated.

Referring back to step 117, if the determination is that confidentiality has not been accepted by substantially all parties attending the session, at least the current portion of the recording is processed in step 137 as including confidential information. As previously mentioned, processing a portion of a recording as including confidential information may include adding a banner to the recording which identifies the confidential information as being confidential and/or blacking out confidential information, e.g., substantially stopping the recording while confidential information is shared such that the confidential information is not recorded.

Once the current portion of the recording is processed as including confidential information, the session is treated as including confidential information in step 141, and may indicate that all parties or participants in the session have not accepted confidentiality. A party that has not accepted confidentiality may be dropped from, e.g., logged out of, the session. It should be appreciated that a session, e.g., a web conference, may provide information to participants which indicates that a party that has not accepted confidentiality has been dropped from the session. Alternatively, when confidential information is being viewed during a session, a display presented to a party that has not accepted confidentiality may be blacked out such that the party is unable to view the confidential information. A conferencing system may indicate the identities of attendees who have not accepted confidentiality and, thus, such attendees may be effectively be disabled for a conference session and unable to view and/or to listen to the conference session. In one embodiment, when a party participates in a session through an audio bridge and does not view video, the party may be prevented from receiving audio packets or otherwise listening to the session while confidential information is shared, if the party has not accepted confidentiality. Preventing audio packets from being received may involve disconnecting a party from a call or placing the party on hold until after confidential information is no longer being shared.

A determination is made in step 145 as to whether confidential information is still indicated. That is, it is determined whether confidential information is still being shared or otherwise presented during the session. If it is determined that confidential information is not still indicated, then in step 151, the current portion of the recording is no longer processed as being confidential, and the session is no longer treated as being confidential. It should be appreciated that the parties or participants that did not accept confidentiality may once again be allowed to join the session and/or allowed to view information shared during the session. The session continues, and the recording of the session continues, without confidentiality in step 153. From step 153, process flow proceeds to step 113 in which it is determined if the recording of the session has been terminated.

Returning to step 145, if it is determined that confidential information is still indicated, then it is determined in step 147 whether the recording of the session has been terminated. If the recording of the session has been terminated, the implication in the described embodiment is that the session has been completed. As such, the recording of the session is stored in step 149, and the process of conducting a session is completed.

Alternatively, if it is determined in step 147 that the recording of the session has not been terminated, then process flow moves to step 117 in which it is determined whether confidentiality has been accepted by substantially all parties attending the session. It should be appreciated that parties which have previously not accepted confidentiality may decide to accept confidentiality.

As mentioned above, when a portion of a session involves sharing confidential information, a recording of the session may be processed such that the confidential information is either clearly identified or effectively not included, e.g., not shown, in the recording. With reference to FIG. 2, a first method of processing at least a current portion of a session or recording as being confidential, e.g., step 121 of FIGS. 1A-C, that involves identifying the portion as including confidential information will be described in accordance with an embodiment. A method 121′ of processing a current portion of a recording as confidential begins at step 205 in which an indication of confidentiality is provided in the recording. The indication of confidentiality may vary widely. An indication may be a blackout of the current portion of the recording, e.g., the current portion of the recording may display a blank screen and include no sound while confidential information is being shared or presented during the session. Alternatively, an indication may include displaying text, or displaying an icon, which indicates confidentiality during the current portion of the recording. An indication of confidentiality is generally provided for the duration of confidentiality, i.e., until the recording no longer needs to be processed as being confidential.

Once an indication of confidentiality is provided in the recording, points in the session at which confidentiality is effectively in place are tracked in step 209. That is, information relating to the time at which confidential information is first shared is identified and, in one embodiment is stored in a dynamic buffer. It should be appreciated that once confidential information is no longer shared, the time at which the confidential information is no longer stored may also be identified and stored in the dynamic buffer. Storing a start time and an end time associated with when confidential information is presented or shared during a session may allow a confidential portion of a recording to be restricted to being accessed by participants who have agreed to maintain confidentiality, e.g., to observe an NDA. After points in the session at which confidentiality is in place are tracked, the method of processing a current portion of a recording as confidential is completed.

FIG. 3 is a process flow diagram which illustrates a second method of processing at least a current portion of a recording as being confidential, e.g., step 121 of FIGS. 1A-C, that involves at least temporarily stopping the recording in accordance with an embodiment. A method 121″ of processing a current portion of a recording as confidential begins at step 305 in which a recording is paused while confidentiality is in place, or while confidential information is being shared during the session. It should be appreciated that the recording may be paused, or stopped, until confidential information is no longer being shared, at which time the recording may effectively be un-paused, or otherwise restarted. In other words, while the current portion of the session is confidential, the recording is paused.

After the recording is paused, points in the session at which confidentiality is effectively in place are tracked in step 309. That is, information relating to the time at which confidential information is first shared is identified and, in one embodiment is stored in a dynamic buffer. The time at which the recording is paused is placed in a dynamic buffer. It should be appreciated that the time at which the recording is un-paused may also be placed in the dynamic buffer. As a result, access to confidential information of a session may be substantially restricted to participants or attendees who have agreed to maintain confidentiality. Once points in the session at which confidentiality is in place are tracked, the method of processing a current portion of a recording as confidential is completed.

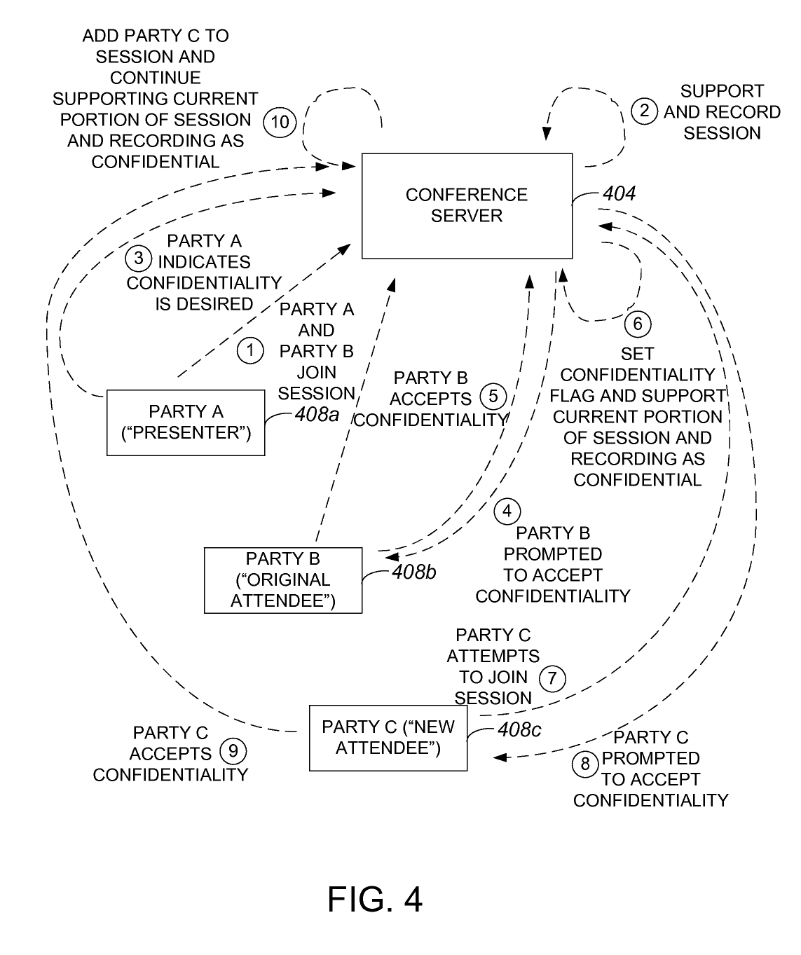

In one embodiment, a party may attempt to join a collaborative session such as a conference session while confidential information is being shared. Such a party may not be allowed to join the ongoing collaborative session unless he or she agrees to accept confidentiality. FIG. 4 is a diagrammatic representation of a process of supporting an addition of a new party to a session in which confidential information is being shared in accordance with an embodiment. At a time t1, a party “A” 408a and a party “B” 408b join a session, e.g., a collaborative session, supported by a conference server 404. In the described embodiment, party “A” 408a is a presenter or a host of the session, and party “B” 408b is an original attendee or participant in the session.

At a time t2, conference server 404 supports and records the session. During the course of the session, at a time t3, party “A” 408a indicates that confidentiality is desired. Party “A” 408a may use an interface provided by conference server 404 to specify that confidentiality is desired. It should be appreciated that by specifying that confidentiality is desired, party “A” 408a is essentially agreeing to maintain confidentiality. In response to party “A” 408a indicating that confidentiality is desired, conference server 404 may provide interfaces, e.g., radio buttons displayed on a graphical user interface, to substantially all attendees, e.g., to party “B” 408b, which allow the attendees to accept confidentiality. Thus, at a time t4, conference server 404 prompts party “B” 408b to accept confidentiality.

In the described embodiment, party “B” 408b accepts confidentiality at a time t5. That is, party “B” 408b agrees to maintain information that is to be shared during the session in confidence. Accepting confidentiality may include, but is not limited to including, effectively accepting a non-disclosure agreement (NDA) or other confidentiality agreement

Once party “B” 408b accepts confidentiality, all parties 408a, 408b currently attending the session have effectively accepted confidentiality. As such, conference server 404 sets a confidentiality flag at step t6 to indicate that a current portion of the session is confidential. Conference server 404 also supports the current portion of the session, and the corresponding portion of the recording, as confidential.

At a time t7, a party “C” 408c attempts to join the ongoing session as a new attendee or participant. That is, party “C” 408c requests admittance to the ongoing session. When conference server 404 detects that party “C” 408c is attempting to join the session, conference server 404 prompts party “C” 408c to accept confidentiality at a time t8. Conference server 404 typically provides an interface to party “C” 408c which allows party “C” 408c to accept confidentiality.

In general, party “C” 408c is not allowed to join the session while the session is confidential unless party “C” 408c agrees to comply with confidentiality requirements. At a time t9, party “C” 408c accepts confidentiality by indicating to conference server 404 that party “C” 408c agrees to maintain confidentiality. Once server 404 is made aware that party “C” 408c has accepted confidentiality, conference server 404 adds party “C” 408c to the session at a time t10, and continues supporting the current portion of the session and the recording as confidential. In one embodiment, when a new party such as party “C” 408c joins a session, text may be displayed and/or audio may be played which indicates that the party has joined the session, and has agreed to maintain confidentiality.

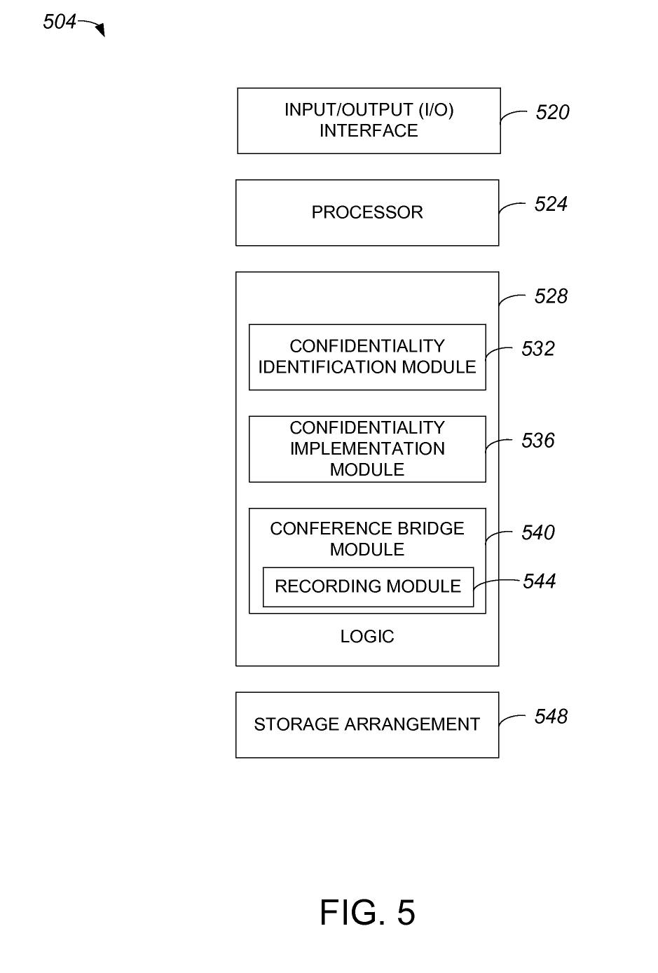

A node or network element, e.g., a conference server, that supports sessions and, hence, recordings for which confidentiality may be maintained will be described with reference to FIG. 5. FIG. 5 is a diagrammatic representation of a server, e.g., a conference server, that is configured to effectively indicate and protect confidential information associated with a session, as well as a recording, in accordance with an embodiment. A server 504 includes an input/output (I/O) interface 520 that allows server 504 to communicate within a network, e.g., with devices or other nodes (not shown) used by parties participating in a collaboration session. I/O interface 520 may include at least one I/O port which allows server 504 to send and to receive information over a network connection.

Server 504 also includes a processor 524, logic 528, and a storage arrangement 548. Logic 528 generally includes hardware and/or software logic that is arranged to be executed by processor 524. Logic 528 includes a confidentiality identification module 532, a confidentiality implementation module 536, and a conference bridge module 540.

Confidentiality identification module 532 is arranged to determine when server 504 has received a request, e.g., from a conference host, to implement or otherwise maintain confidentiality during a collaboration session. Confidentiality identification module 532 is also configured to provide interfaces which allow parties to accept confidentiality.

Confidentiality implementation module 536 is configured to implement confidentiality with respect to a collaboration session, as well as a recording of the collaboration session. Confidentiality implementation module 536 generally obtains an indication from confidentiality identification module 532 regarding whether parties participating in a collaboration session have agreed to maintain confidentiality, and implements confidentiality accordingly. Implementing confidentiality may include, but is not limited to including, setting a confidentiality flag to indicate that a collaboration session is confidential, providing an indication on screens displayed during the collaboration session that the collaboration session is currently confidential, and processing a recording of the collaboration session to indicate confidentiality. In one embodiment, when not all parties in a collaboration session have accepted confidentiality, confidentiality implementation module 536 may be arranged to effectively prevent parties that have not accepted confidentiality from viewing or otherwise receiving confidential information.

Conference bridge module 540 allows server 504 to support collaboration sessions, and generally provides functionality which allows multiple parties to join a collaboration session. Conference bridge module 540 typically supports an audio bridge and a video bridge. As shown, conference bridge module 540 includes a recording module 544 which allows a collaboration session to be recorded. Recording module 544 is configured to cooperate with confidentiality implementation module 536 to provide indications of confidentiality in a recording of a collaboration session, when appropriate.

Server 504 also includes a storage arrangement 548 that is configured to store recordings of collaboration sessions. In one embodiment, storage arrangement 548 is further configured to store information relating to points, e.g., times, in a collaboration session at which confidentiality begins to be indicated and points, e.g., times, in the collaboration session at which confidentiality ceases to be indicated.

Although only a few embodiments have been described in this disclosure, it should be understood that the disclosure may be embodied in many other specific forms without departing from the spirit or the scope of the present disclosure. By way of example, while indicating when confidential information is shared or presented has generally been described in the context of a session or a meeting that is a collaboration session, indicating when confidential information is shared is not limited to being associated with a collaboration session. An audio indication may be played when confidential information is shared during an audio conference, and the audio indication may continue to play until confidential information is no longer being shared.

A particular application, file, or document that is identified as containing confidential information during the course of a collaboration session may be revisited during a later portion of the collaboration session. That is, shared information that each party in a collaboration session has agreed to keep confidential may be accessed again at a later time during the collaboration session, after non-confidential information is shared. For example, when a slide that is presented at a first time during a collaboration session contains confidential information and the slide is accessed again at a second time during the collaboration session, a conference server may recall that the slide was previously identified as confidential at the first time, and may substantially automatically indicate that the slide is confidential at the second time. Hence, even if the collaboration session is not confidential between the first time and the second time, confidentiality may be substantially automatically re-established at the second time when the slide is once again shared or presented as appropriate. For example, when the attendees of the collaboration session are the same at the first time and at the second time, then the session may have similar properties at the second time as it had at the first time. If confidentially is applied substantially automatically when a conference session is initiated or otherwise established, attendees who were disabled and/or dropped substantially automatically with respect to the conference session when the conference session was initiated may be prompted more than once to accept confidentiality, e.g., after confidential information is presented and non-confidential information is being shared.

A host of a collaboration session has generally been described as being provided with functionality which enables confidential information to be indicated during the collaboration session. In other words, a host of a collaboration session may specify when substantially all attendees or parties participating in the collaboration session are to accept confidentiality before the confidential information may be shared. In lieu of a host of a collaboration session specifying when confidential information is to be shared, other participants in the collaboration session may also specify when confidential information is to be shared. For instance, a party who currently has floor control during a collaboration session may be provided with an ability to specify when confidential information is to be shared. When a party who currently has floor control, e.g., a current presenter, during a collaboration session specifies that confidential information is to be shared, substantially all other parties, including a host of the collaboration session, may generally be asked to confirm that they are amenable to maintaining confidentiality before the confidential information is shared. Alternatively, in one embodiment, participants may agree to and store acceptance of their confidentiality before or during a session and, as such, the participants may substantially avoid being repeatedly prompted to accept confidentiality during a session.

A host of a collaboration session may effectively make a selection which indicates whether a recording of a session is to be stopped while confidential information is shared, or whether a recording of a session is to continue while confidential information is shared. In other words, a determination of how to process a recording when confidential information is being shared may be made by a host of a collaboration session. When the recording of the session is to continue while confidential information is shared, the confidential information may be blacked out or otherwise obscured in the recording session.

In one embodiment, specific applications, files, and/or documents shared by a participant during a collaboration session may effectively be tagged as confidential. As such, whenever applications, files, and/or documents tagged as confidential are shared during a collaboration session, a server that supports the collaboration session may substantially automatically request that each party participating in the collaboration session agrees to maintaining confidentiality before the applications, files, and/or documents are shared.

It should be appreciated that a host or a presented may provide an indication that confidential information has already been presented, i.e., that confidential information was presented at a time prior to a current time. When confidential information has already been presented, a confidential flag may be marked to indicate that confidential information was shared. The confidential flag may be associated, for example, with a statement that confidential information was shared “starting at X amount of time before a current time” or that confidential information was shared “from the beginning of the session.” A recording of a conference session may be marked to indicate when confidential information is shared, and/or may be marked to indicate that the entire recording includes confidential information.

Confidentiality may be maintained as different applications are presented during a collaboration session, as well as when different presenters have floor control during a collaboration session. In other words, confidentiality for a session may effectively be in place until it is removed, e.g., removed by a host of the session, even as different applications are shared and as different presenters have floor control.

A confidential status may be disabled by a host or even a presenter during a collaboration session at substantially any time. When a host disables a confidential status, information may be presented during a session which indicates that the confidential portion of the session has ended.

In general, a party attending a collaboration session has been described as being presented with a graphical user interface that allows the party to make a selection, e.g., press or activate an appropriate radio button. In addition to being provided with a graphical user interface, a message may be played during the collaboration session which indicates that confidential information will be shared or discussed, while a graphical user interface may prompt parties attending the collaboration session to provide input which indicates that they accept confidentiality. When a party attends a collaboration session using substantially only audio, e.g., using substantially only an audio bridge, the party may be allowed to enter digits using a phone keypad or the like to accept confidentiality, or to vocally accept confidentiality.

When confidential information is shared during a collaboration session, functionality, functionality associated with devices used by attendees of the collaboration system may be at least temporarily disabled. By way of example, when confidential information is shared, devices used by attendees to participate in the collaboration session may be disabled such that the attendees are unable to take screen shots of the collaboration session. Alternatively, if a screen shot is taken of a display screen while confidential information is shared, a notification may be sent, e.g., to a host of the collaboration session, which indicates that the screen shot was taken. A participant in violation of confidentiality may be automatically removed from as session. It should be appreciated that the identify of a participant in violation of confidentiality may be maintained, and information pertaining to his or her violation of confidentiality may be stored, e.g., as part of the session.

In one embodiment, when confidential information is shared during a collaboration session, different versions of the collaboration session may effectively be recorded. For instance, one recording of a collaboration session may include substantially all of the confidential information, while another recording of the collaboration session may black out or eliminate substantially all of the confidential information. Further, the recording of the collaboration session which includes substantially all of the confidential information may be password protected such that only parties with the correct password, e.g., parties who agreed to maintain confidentiality, may access the recording.

Confidential information may effectively be assumed to be shared during a collaboration session. In other words, at the beginning of a collaboration session, an indication that confidential information is to be shared during the collaboration session may be provided, and the collaboration session may be substantially conducted as a including confidential content unless a host or presenter disables the confidential status.

The ability to accept confidentially has been described as being provided through an interface displayed on a screen used to view information associated with a session. It should be understood that the ability to accept confidentiality is not limited to being provided through an interface displayed on a screen. For example, accepting confidentiality may occur through entering at least one dual-tone multi-frequency (DTMF) digit or responding vocally to a prompt. In one embodiment, participants attending a session using substantially only audio may respond to voice prompts by entering DTMF digits or speaking.

A web conferencing system may generally challenge each participant in a session to authenticate themselves again when accepting confidentiality. Participants may authenticate themselves with respect to a session using any suitable method, as for example by providing a secret key and/or a conference password.

A file which contains a recording of a session in which confidential information was shared may be password protected to further protect the confidentiality of the confidential information stored in the file. A password which may be used to gain access to the file may be provided substantially only to participants who accepted confidentiality. That is, a password may be provided to selected participants which may allow the selected participants to access and/or to download a file which contains a recording that includes confidential information. It should be appreciated that a host, for example, may modify access rights to a file that contains confidential information and effectively determine who may access the file. In one embodiment, a party without a password to access a file may be allowed to access substantially only non-confidential portions of the file.

A file which contains a recording of a session in which confidential information was shared may be marked such that substantially the entire file or recording is marked as confidential. Substantially all attendees of the session may be notified, as for example through email, to remind the attendees that the file which contains the recording of the session contains confidential information which should not be shared.

When an invitation to a meeting or a session is issued, an indication may be provided in the invitation, or may otherwise be attached to the invitation, which indicates that the meeting is a confidential meeting. Options may be provided to recipients of the invitation which allow the recipients to specify whether or not they are in agreement with maintaining confidentiality with respect to information shared during the meeting. In one embodiment, unless an attendee responds to an invitation by indicating that he or she agrees to maintain confidentiality, he or she may be prevented from joining the meeting. In such an embodiment, a meeting may automatically be designated as a confidential session, as substantially only participants who agree to maintain confidentiality may be allowed to join the meeting.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples is not to be limited to the details given herein, but may be modified within the scope of the appended claims.

What is claimed is:

1. A method comprising:
initiating a session, the session including a plurality of participants in attendance, the plurality of participants including at least a first participant and a second participant;
allowing the plurality of participants to participate in the session;
determining whether a first indication is obtained, the first indication being arranged to indicate that confidential information is to be shared during the session;
after it is determined that the first indication is obtained, determining whether each participant of the plurality of participants has agreed to maintain confidentiality with respect to the confidential information; and
after it is determined that each participant of the plurality of participants has agreed to maintain the confidentiality with respect to the confidential information, providing a second indication during the session and allowing the plurality of participants to continue participating in the session, the second indication being arranged to indicate that the confidential information is currently being shared during the presentation.

2. The method of claim 1 wherein the first participant attends the meeting using a first device with a first display screen and the second participant attends the meeting using a second device with a second display screen, and wherein the second indication is displayed on the first display screen and on the second display screen.

3. The method of claim 1 further including:
initiating a recording of the session, wherein after it is determined that the first indication is obtained, the recording is paused while the confidential information is shared.

4. The method of claim 1 further including:
initiating a recording of the session, wherein after it is determined that the first indication is obtained, the recording continues while the confidential information is shared with the confidential information being blacked out in the recording.

5. The method of claim 1 further including:
determining when a first party requests admittance to the session while the confidential information is currently being shared;
determining when the first party has agreed to maintain the confidentiality with respect to the confidential information;
joining the first party into the session when it is determined that the first party has agreed to maintain the confidentiality with respect to the confidential information; and
preventing the first party from joining the session when it is determined that the first party has not agreed to maintain the confidentiality with respect to the confidential information.

6. The method of claim 1 wherein determining whether the first indication is obtained includes obtaining the first indication from the first participant, and wherein determining whether each participant of the plurality of participants has agreed to maintain the confidentiality include providing an interface to the second participant and obtaining a third indication from the second participant through the interface, the third indication being arranged to indicate that the second participant has agreed to maintain the confidentiality.

7. The method of claim 1 further including:
determining when a third indication is obtained, the third indication being arranged to indicate that confidential information is no longer to be shared during the session; and
when it is determined that the third indication is obtained, ceasing providing the second indication during the session.

8. The method of claim 1 wherein determining whether each participant of the plurality of participants has agreed to maintain the confidentiality with respect to the confidential information includes determining when the second participant has agreed to maintain the confidentiality with respect to the confidential information, wherein when it is determined that the second participant has not agreed to maintain the confidentiality with respect to the confidential information, the method further includes:
preventing the second participant from sharing the confidential information.

9. A tangible, non-transitory computer-readable medium comprising computer program code, the computer program code, when executed, configured to:
initiate a session, the session including a plurality of participants in attendance, the plurality of participants including at least a first participant and a second participant;
allow the plurality of participants to participate in the session;
determine whether a first indication is obtained, the first indication being arranged to indicate that confidential information is to be shared during the session;
after it is determined that the first indication is obtained, determine whether each participant of the plurality of participants has agreed to maintain confidentiality with respect to the confidential information; and
after it is determined that each participant of the plurality of participants has agreed to maintain the confidentiality with respect to the confidential information, provide a second indication during the session and continue to allow the plurality of participants to participate in the session, the second indication being arranged to indicate that the confidential information is currently being shared during the presentation.

10. The tangible, non-transitory computer-readable medium comprising computer program code of claim 9 wherein the first participant attends the meeting using a first device with a first display screen and the second participant attends the meeting using a second device with a second display screen, and wherein the second indication is displayed on the first display screen and on the second display screen.

11. The tangible, non-transitory computer-readable medium comprising computer program code of claim 9, wherein the computer program code is further configured to:
initiate a recording of the session, wherein after it is determined that the first indication is obtained, the recording is paused while the confidential information is shared.

12. The tangible, non-transitory computer-readable medium comprising computer program code of claim 9, wherein the computer program code is further configured to:
initiate a recording of the session, wherein after it is determined that the first indication is obtained, the recording continues while the confidential information is shared with the confidential information being blacked out in the recording.

13. The tangible, non-transitory computer-readable medium comprising computer program code of claim 9, wherein the computer program code is further configured to:
determine when a first party requests admittance to the session while the confidential information is currently being shared;
determine when the first party has agreed to maintain the confidentiality with respect to the confidential information;
join the first party into the session when it is determined that the first party has agreed to maintain the confidentiality with respect to the confidential information; and
prevent the first party from joining the session when it is determined that the first party has not agreed to maintain the confidentiality with respect to the confidential information.

14. The tangible, non-transitory computer-readable medium comprising computer program code of claim 9 wherein the computer program code configured to determine whether the first indication is obtained is further configured to obtain the first indication from the first participant, and wherein the computer program code configured to determine whether each participant of the plurality of participants has agreed to maintain the confidentiality is further configured to provide an interface to the second participant and to obtain a third indication from the second participant through the interface, the third indication being arranged to indicate that the second participant has agreed to maintain the confidentiality.

15. The tangible, non-transitory computer-readable medium comprising computer program code of claim 9 wherein the computer program code is further configured to:
determine when a third indication is obtained, the third indication being arranged to indicate that confidential information is no longer to be shared during the session; and
when it is determined that the third indication is obtained, cease providing the second indication during the session.

16. The tangible, non-transitory computer-readable medium comprising computer program code of claim 9 wherein the computer program code configured to determine whether each participant of the plurality of participants has agreed to maintain the confidentiality with respect to the confidential information includes computer program code configured to determine when the second participant has agreed to maintain the confidentiality with respect to the confidential information, wherein when it is determined that the second participant has not agreed to maintain the confidentiality with respect to the confidential information, the computer program code is further configured to:
prevent the second participant from sharing the confidential information.

17. An apparatus comprising:
a logic module, the logic module including a confidentiality identification module and a confidentiality implementation module, the logic module further including a conference bridge module, wherein the conference bridge module is configured to support a session, and wherein the confidentiality identification module is configured to determine whether at least a portion of the session includes confidential information and the confidentiality implementation module is arranged to cause at least the portion of the session to be identified as being confidential; and
a processor, the processor being configured to execute the logic module.

18. The apparatus of claim 17 further including:
an input/output (I/O) interface, the I/O interface being arranged to obtain a first indication from a first participant in the session, wherein the confidentiality identification module is configured to determine whether the first indication indicates that the portion of the session includes the confidential information.

19. The apparatus of claim 18 wherein the confidentiality identification module is further configured to determine whether at least a second participant in the session agrees to maintain confidentiality with respect to the confidential information, and wherein after it is determined that at least the second participant in the session agrees to maintain the confidentiality with respect to the confidential information, the confidentiality implementation module causes at least the portion of the session to be identified as being confidential.

20. The apparatus of claim 18 wherein the conference bridge module includes a recording arrangement, the recording arrangement being arranged to create a recording of the session, wherein after it is determined that the first indication indicates that the portion of the session includes the confidential information, the recording arrangement is further configured to prevent the portion of the session from being included in the recording.
